(19) United States
(12) Patent Application Publication
(10) Pub. No.: US 2002/0124007 A1
(43) Pub. Date: Sep. 5, 2002

(54) Network server and database therein

(75) Inventor: Yijun Zhao, Wuhan (CN)

Correspondence Address: KENNETH C. BOOTH, SCHMEISER, OLSEN & WATTS LLP, 18 EAST UNIVERSITY DRIVE, #101, MESA, AZ, 85201, US

(73) Assignee: Wuhan P&S Electronics Company Ltd.

(21) Appl. No.: 09/798,256

(22) Filed: Mar. 2, 2001

(51) Int. Cl. G06F 7/00

(52) U.S. Cl. 707/102

(57) ABSTRACT

A network server (20) establishes communication between devices (15A-15N) in an Intranet (16) and a network (11). The network server (20) has a database (30) storing device property tables (35A-35N) and object property tables (A1-Ai, B1-Bj, . . . , N1-Nk), which are periodically mapped from the devices (15A-15N). The database (30) enables the identification, description, controlling, monitoring, and modification of the objects in a device (15A) from multiple clients on the network (11). The database (30) further allows the exchange of date among the devices (15A-15N) in the Intranet (16). The database (30) also provides a platform and independent communication process between the network (11) and the devices (15A-15N).

### FIELD OF THE INVENTION

The present invention relates, in general, to network communication and, more particularly, to a network server for establishing communication between a device and a network.

### BACKGROUND OF THE INVENTION

Electronic devices are widely used in various aspects of daily life. Many electronic devices, such as those found in mobile telephones, automobile control systems, vending machines, utility meters, security systems, medical monitoring systems, etc., include processing circuits such as, for example, embedded microcontroller units (MCUs) for performing different functions and processes. It is often desirable to connect the MCU in an electronic device to a network such as Internet, so that the operation of the electronic device can be remotely monitored and/or controlled.

One approach for connecting a processing circuit such as an MCU to a network is to program a network protocol, e.g., Transmission Control Protocol/Internet Protocol (TCP/IP), into the MCU. An MCU with TCP/IP programmed therein can access Internet through a modulation and demodulation device (MODEM). This approach normally needs an MCU of at least 16 bits. It also needs a large memory, e.g., at least 32 kilobytes, and a high operating speed in order to achieve a satisfactory performance. Furthermore, this approach does not provide an application platform independent communication process between the MCU and the network. The engineers who program the MCU must be familiar not only with the applications of the MCU but also with the TCP/IP protocol and related interfaces. Therefore, this approach usually requires a long development period, a high performance chip, and is cost inefficient.

Another approach for connecting a processing circuit such as an MCU to a network is to establish an off chip network interface, e.g., an interface developed by emWare, Inc. under the trademark “emGateway”, and program a network interface compatible protocol, e.g., a protocol developed by emWare, Inc. under the trademark “emNet”, into the MCU. An MCU with emNet programmed therein can access Internet via the network interface emGateway. The emNet is built on the concept of distributed memory architecture that shares variables, events, functions, and messages between the emGateway and the MCU. This shared memory concept adversely affects the application programming flexibility as well as the integrity and operation of the MCU. Furthermore, shared memory concept of emWare and emGateway does not provide an object oriented environment for the network to access the MCU. Therefore, emWare and emGateway do not provide an application platform independent communication system. Although emNet requires less memory than TCP/IP, this approach still requires the design engineers to be familiar not only with the application of the MCU but also with the emNet and related interfaces. Therefore, this approach often also requires a long development period, a relatively high performance chip, and is cost inefficient.

Accordingly, it would be advantageous to have a cost efficient communication system between an intelligent device, e.g., a device that includes a microprocessor, a digital signal processor, an MCU, etc., and a network, e.g., Internet. It is desirable for the system to be simple and reliable. It is also desirable for the communication system not to adversely affect the integrity and operation of the intelligent device. It would be of further advantage for the system to be compatible with different types of devices in terms of capabilities and performances.

### SUMMARY OF THE INVENTION

A general aspect of the present invention is to provide a simple and cost efficient system for communicating between an intelligent device and a network. An intelligent device is defined as a device that includes a processing circuit, e.g., a microprocessor (μP), a microcontroller unit (MCU), a digital signal processor, (DSP), a central processing unit (CPU), etc. A particular aspect of the present invention is to ensure that the integrity of the intelligent device is not adversely affected by the communication system. An additional aspect of the present invention is to provide the communication system that is platform independent. A further aspect of the present invention is to establish a communication between the network and intelligent devices with wide spectra of applications, capabilities, performances, bit numbers, memory sizes, etc.

In order to achieve these and other aspects of the present invention, a communication system between an intelligent device and a network is established by coupling an intelligent device communication network server, a network interface, or a network gateway between the intelligent device and the network. Preferably, the intelligent device communication network server is capable of communicating with multiple intelligent devices. The intelligent device communication network server, which can be simply referred to as a network server, and the intelligent devices coupled thereto form an Intranet, which is also referred to as an intelligent device communication network. An Intranet communication protocol is implemented for the communication between the network server and the intelligent devices. The network server serves as a communication relay between different intelligent devices within the Intranet as well as a communication relay between the intelligent device communication network and the network such as, for example, Internet. Therefore, the network server functions as an intermediary between different intelligent devices within the Intranet and between the intelligent devices and the network.

A signal in the network typically follows a network protocol. For example, a signal in Internet typically follows Transmission Control Protocol/Internet Protocol (TCP/IP). In accordance with the present invention, the communications between the network server and the intelligent devices follow an Intranet communication protocol. The Intranet communication protocol establishes a master-slave relationship between the network server and the intelligent devices. As a master with respect to the intelligent devices, the network server can send commands and requests to the intelligent devices. As a slave respect to the network server, an intelligent device responds the commands and requests from the network server. The intelligent device does not initiate commands and requests to the network server. When connected to the network server, the intelligent device can report an event to the network server in response to an event polling command from the network server. Preferably, the network server periodically sends event polling commands to the intelligent device, thereby enabling the intelligent device to timely report events to the network server.

Preferably, an intelligent device in the intelligent device communication network has a memory unit storing a device property table and a plurality of object property tables for objects associated with that device. The parameters in the object property tables determine and/or describe the state and operation of the intelligent device. Depending on the nature of the intelligent device, the objects can be constants, variables, events, functions, and files. When the network server is connected to an intelligent device, the device property table and the object property tables in the intelligent device are mapped into the network server.

The network server creates a database that includes the device property tables and the object property tables mapped for the intelligent devices in the Intranet. Preferably, the database also includes a device index table listing all intelligent devices in the Intranet. Thus, an intelligent device in the Intranet is represented by a corresponding entry, which is also referred to as a device, in the device index table. Each entry in the device index table points to a device property table that includes a list of objects. The list of objects in the device property table provides the addresses of the object property tables for the objects associated with the device. When a client on the network seeks access to an intelligent device in the Intranet, it sends an access request to the network server. Using the device index table, the network server locates the device property table and the object property tables of the intelligent device in the database. Through the database in the network server, a client on the network, e.g., Internet, can access, monitor, and control an object, e.g., temperature, in an intelligent device in the intelligent device communication network.

The database on the network server is preferably accessible by multiple clients on the network simultaneously. In addition, the network server is preferably able to send data in the database regarding one intelligent device to another intelligent device in the Intranet. Therefore, the database in the network server provides a data sharing environment that makes the data regarding an intelligent device in the Intranet accessible by multiple clients coupled to the network server and by other intelligent devices in the Intranet. The database also insulates intelligent devices in the Intranet from the clients in the network and from other intelligent devices in the Intranet. A client on the network seeking access to an intelligent device can only access the data regarding the intelligent device in the database on the network server. The client does not directly access the intelligent device. When a client seeks to read an object in an intelligent device, the client reads the data of the object in the database on the network server. When a client seeks to modify an object in an intelligent device, the client writes the data regarding the object into the database on the network server. The network server then transmits the new data in the database to the intelligent device. The indirect reading and writing processes in accordance with the present invention effectively insulate the operation of the intelligent device from any possible interference from the client on the network.

The network server in accordance with the present invention can establish communications between networks and intelligent devices of various capabilities and performances. The database enables the network server to be application platform and operating system independent. The operation of the network server does not depend on the application platforms in the processing circuits of the intelligent devices. The network server significantly improves the simplicity and reliability of the communication process.

### BRIEF DESCRIPTION OF THE DRAWINGS

FIG. 1 is a block diagram of a communication system in accordance with the invention;

FIG. 2 is a functional block diagram illustrating a network server in accordance with the invention;

FIG. 3 illustrates a database in a network server in accordance with the invention;

FIG. 4 illustrates a device index table in a database in accordance with the invention;

FIG. 5 illustrates a device property table in a database in accordance with the invention;

FIG. 6 illustrates an object property table in a database in accordance with the invention; and

FIG. 7 illustrates a description section in an object property table in a database in accordance with the invention.

### DETAILED DESCRIPTION OF THE PREFERRED EMBODIMENTS

Various embodiments of the present invention are described herein below with reference to the figures, in which elements having similar functions are labeled using the same or related reference numerals in the figures. It should be understood that the scope of the present invention is not limited to those embodiments shown in the figures and described herein below.

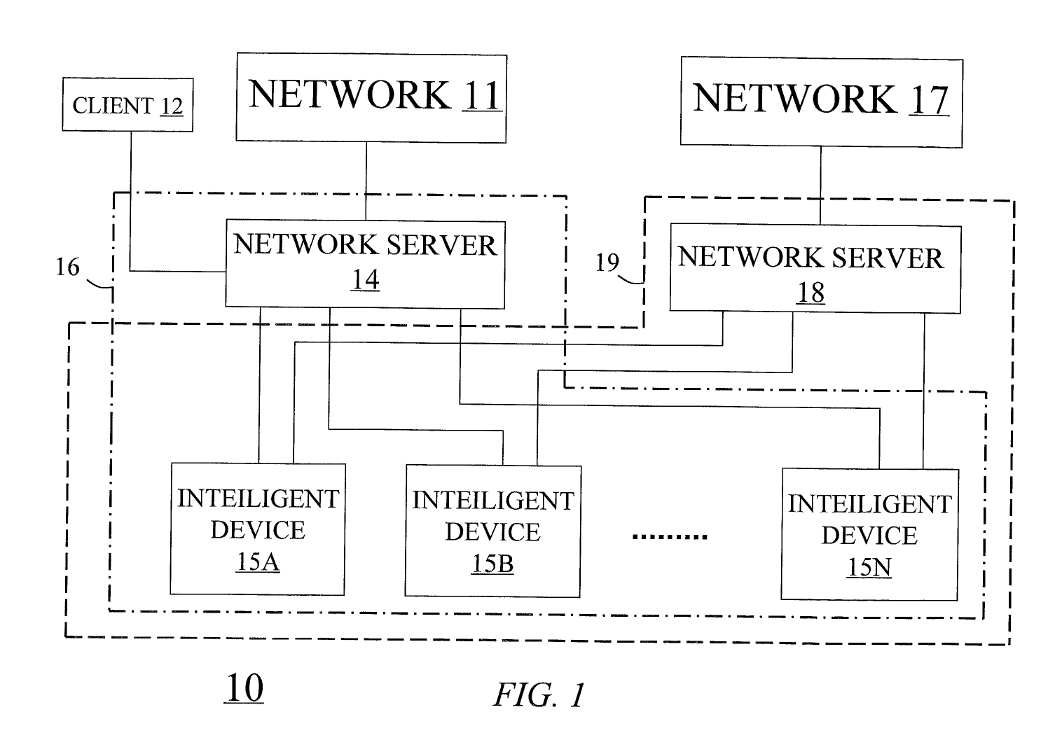

FIG. 1 is a block diagram illustrating a communication system 10 in accordance with the present invention. Communication system 10 includes a network server 14 communicating with a network 11, e.g., Internet. By way of example, network server 14 is installed in a computer, an information server, a database server, a set-top box (STB), or an Internet appliance (IA) (not shown) that has network access. Network server 14 also communicates directly with a client 12, which may be, by way of example, a cellular telephone, a personal digital assistant (PDA), or a wireless digital personal communication service (PCS) apparatus. Communication system 10 also includes another network server 18 communicating with a network 17, e.g., a wireless communication network. By way of example, network server 18 is installed in a PCS, a PDA, a cellular telephone, or a web pad. Communication system 10 further includes a plurality of intelligent devices 15A, 15B, and 15N. Intelligent devices 15A-15N are devices, e.g., utility meters, refrigeration systems, security systems, medical devices, vending machines, navigation systems, telecommunication devices, home appliances, industrial equipment, etc., that include processing circuits or units, e.g., digital signal processor (DSP), microprocessor (μP), central processing unit (CPU), microcontroller unit (MCU), etc. Network server 14 and intelligent devices 15A-15N form an Intranet 16. Likewise, network server 18 and intelligent devices 15A-15N form an Intranet 19. Intranets 16 and 19 are also referred to as intelligent device communication networks.

By way of example, each of intelligent devices 15A-15N includes a signal adapter or a network communication controller (not shown) for signal transmission and reception for respective intelligent device. The signal adapter can include any kind of signal processing circuit such as, for example, DSP, μP, CPU, MCU, communication peripheral, field programmable gate array (FPGA), programmable logic device (PLD), system on chip (SOC), application specific standard product (ASSP), application specific integrated circuit (ASIC), etc. The electronics circuitry in intelligent devices 15A-15N can be formed from single integrated circuit chips, multiple integrated circuit chips, discrete devices, and any combination thereof. As an example, the signal adapter and the processing circuit of intelligent device 15A are formed on two integrated circuit chips coupled to each other via internal buses such as, for example, Peripheral Component Interconnect (PCI) bus, Serial Peripheral Interface (SPI) bus, or Inter-Integrated Circuit (I²C) bus. Also as an example, the signal adapter and the processing circuit of intelligent device 15B are formed on the same integrated circuit chip.

Network servers 14 and 18 communicate with respective networks 11 and 17 using network protocols, e.g., TCP/IP, wireless application protocol (WAP), etc. The connection between network server 14 and network 11 can be either wired or wireless. Examples of wired connections include Modulator and Demodulator (MODEM), cable MODEM, Fiber Distributed Data Interface (FDDI), power line, Digital Subscriber Line (DSL), High Speed DSL (HDSL), Asymmetric DSL (ADSL), Integrated Services Digital Network (ISDN), Asynchronous Transfer Mode (ATM), Higher Performance Parallel Interface (HIPPI). Examples of wireless communications include satellite communication, cellular communication, microwave communication.

The connections between network server 14 and intelligent devices 15A-15N in Intranet 16 may be wired and wireless connections. By way of example, network server 18 is a mobile server. Thus, the connections between network server 18 and intelligent devices 15A-15N in Intranet 19 are wireless. The wired communications can be either serial or parallel signal transmissions. Examples of serial signal transmissions include asynchronous data transmissions following the RS-232 and RS-485 serial communication standard published by the Electronic Industries Alliance (EIA), high speed serial transmission following the IEEE 1394 serial data transmission standard published by the Institute of Electrical and Electronics Engineers (IEEE), Universal Serial Bus (USB), Controller Area Network Bus (CANBus), Consumer Electronics Bus (CEBus), Home Phoneline Network Association (HomePNA), interoperable networks following the Home Audio Visual Interoperability (HAVI) standard, Ethernet, etc. The serial signal transmissions are typically more cost efficient and more reliable than parallel signal transmissions. However, the parallel signal transmissions are usually faster than the serial signal transmissions. Examples of wireless communications include radio frequency (RF) communication, Bluetooth communication, and infrared (IR) communication.

The communications between network server 14 and intelligent devices 15A-15N in Intranet 16 and between network server 18 and intelligent devices 15A-15N in Intranet 19 follow an Intranet communication protocol such as, for example, a network communication protocol described in pending U.S. patent application Ser. No. 09/724,801 filed on Nov. 28, 2000, which is incorporated herein by reference.

It should be understood that communication system 10 is not limited to that described herein above. Particularly, communication system 10 is not limited to having two network servers as shown in FIG. 1. In accordance with the present invention, communication system 10 may include any number of network servers, e.g., one, three, four, etc., forming any number of Intranets. Different network servers may be coupled to the same or different networks. Further, different Intranets, e.g., Intranets 16 and 19 shown in FIG. 1, are not limited to including the same intelligent devices, e.g., intelligent devices 15A-15N shown in FIG. 1. In accordance with the present invention, an Intranet may include any number of intelligent devices and an intelligent device may belong to any number of Intranets.

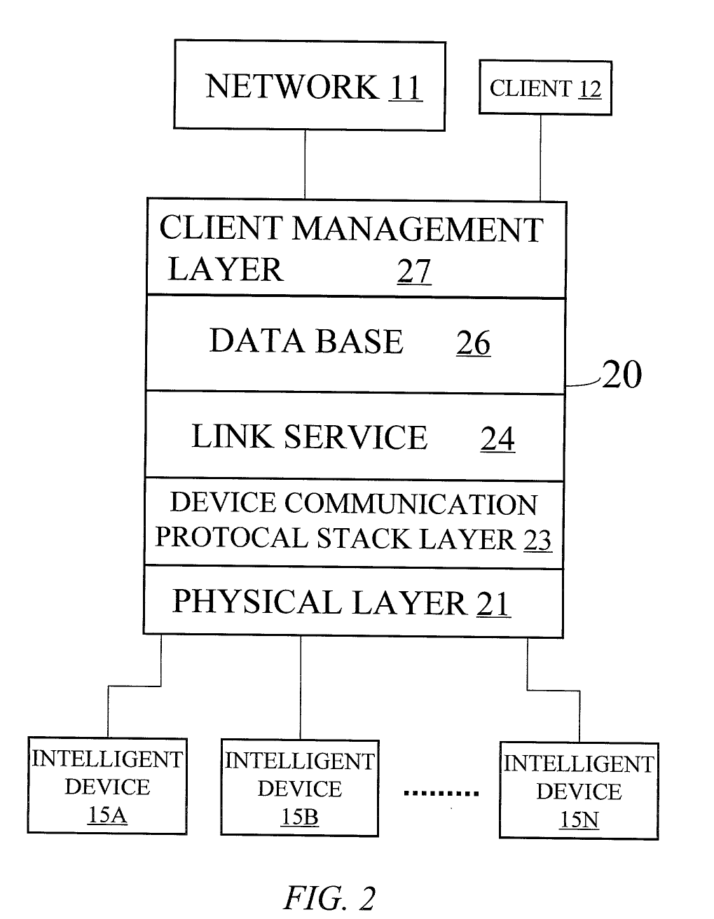

FIG. 2 is a functional block diagram illustrating a network server 20 in accordance with the present invention. Network server 20 can be either network server 14 or network server 18 shown in FIG. 1. By way of example network server 20 communicates with network 11 and client 12, and forms an Intranet 16 with intelligent devices 15A-15N (shown in FIG. 1). Network server 20 functions as an intermediary between clients (not shown) on network 11 and intelligent devices 15A-15N in Intranet 16. Network server 20 functionally has a multiple layer structure. Specifically as shown in FIG. 2, network server 20 includes a physical layer 21, a device communication protocol stack layer 23, link service layer 24, a database layer 26, and a client management layer 27.

Physical layer 21 determines the physical communication models, e.g., RS-232, RS-485, MODEM, IEEE 1394 driver, USB driver, CANBus driver, CEBus driver, Bluetooth transceiver, etc. Physical layer 21 also determines the signal levels during data transmission between network server 20 and intelligent devices 15A-15N. Device communication protocol stack layer 23 performs the functions of controlling data transmission between network server 20 and intelligent devices 15A-15N. Device communication protocol stack layer 23 also packs the down link data into data packets and unpacks the up link data packets. Preferably, device communication protocol stack layer 23 further performs the functions of trouble shooting. Through physical layer 21, device communication protocol stack layer 23 sets up connections between network server 20 and intelligent devices 15A-15N, thereby insuring data transmissions there between. Device communication protocol stack layer 23 preferably supports various types of communication interfaces, e.g., RS-232, RS-485, IEEE 1394, USB, CANBus, CEBus, Bluetooth.

Client management layer 27 serves to manage the clients and the connection modes between network server 20 and intelligent devices 15A-15N. Specifically, when a client on network 11 sends a command signal to network server 20 requesting access to an intelligent device, e.g., intelligent device 15A, in Intranet 16, client management layer 27 preferably checks the device name of device security code in the access command signal to determine the authority and limitation of the client in accessing intelligent device 15A.

Database layer 26 includes the parameters related to the statuses of operations of intelligent devices 15A-15N in Intranet 16. In accordance with the present invention, when a client seeks to an access intelligent device, e.g., intelligent device 15A, in Intranet 16, the client does not directly access intelligent device 15A. Instead, the client accesses the parameters related to status and operation of intelligent device 15A in database layer 26 of network server 20. Database layer 26 is able to insulate intelligent devices 15A-15N in Intranet 16 from inadvertent inferences from the clients accessing intelligent devices 15A-15N.

Link service layer 24 manages the signal transmission to and from intelligent devices 15A-15N. If the access of intelligent device 15A requires a connection between network server 20 and intelligent device 15A to be established, link service layer 24 instructs device communication protocol stack layer 23 and physical layer 21 to establish a connection with intelligent device 15A according to a specified communication route that preferably specifies device communication protocol, port, address or telephone number, and communication speed. Preferably, link service layer 24 can be accessed directly by a system developer or administrator (not shown in FIG. 2) for the development and maintenance of communication system 10.

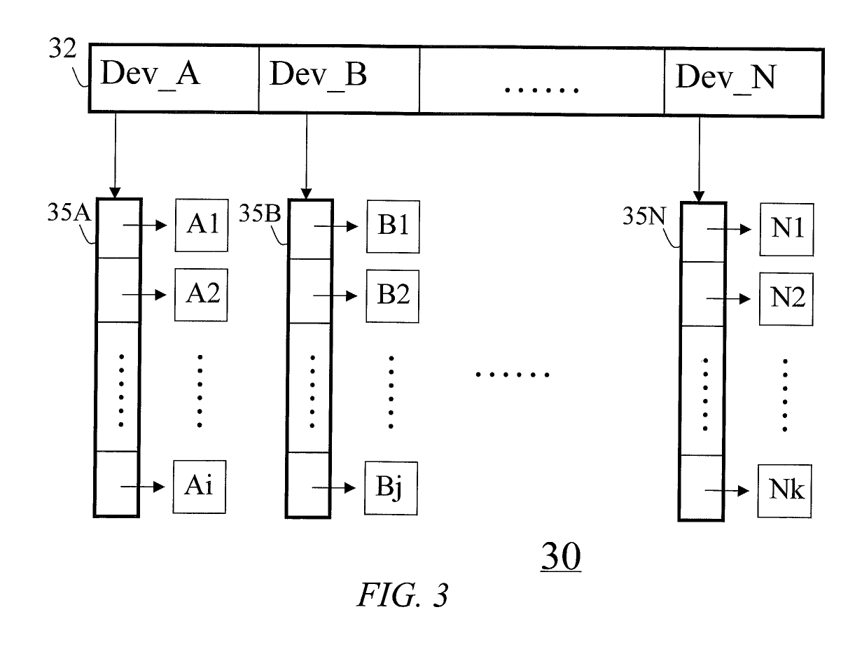

FIG. 3 illustrates a database 30 in network server 20 in accordance with the present invention. Database 30 is set up in database layer 26. Database 30 includes a device index table 32 that preferably lists intelligent devices 15A-15N in Intranet 16. Specifically as shown in FIG. 3, device index table 32 includes entries DEV_A, DEV_B, . . . , and DEV_N, which are also referred to as devices, representing respective intelligent devices 15A, 15B, . . . , and 15N in Intranet 16. Entries DEV_A, DEV_B, . . . , and DEV_N in device index table 32 point to corresponding device property tables 35A, 35B, . . . , and 35N, which characterize intelligent devices 15A, 15B, . . . , and 15N, respectively, in Intranet 16.

For each of intelligent devices 15A-15N, database 30 includes object property tables describing the objects associated therewith. By way of example, intelligent device 15A, 15B, . . . , and 15N have i, j, . . . , and k, respectively, objects associated therewith, with i, j, . . . , and k being any integers. Database 30 includes object property tables A1, A2, . . . , and Ai describing the objects associated with intelligent device 15A. Device property table 35A includes address codes pointing to object property tables A1, A2, . . . , and Ai. Likewise, database 30 includes object property tables B1, B2, . . . , and Bj describing the objects associated with intelligent device 15B. Device property table 35B includes address codes pointing to object property tables B1, B2, . . . , and Bj. Further, database 30 includes object property tables N1, N2, . . . , and Nk describing the objects associated with intelligent device 15N. Device property table 35N includes address codes pointing to object property tables N1, N2, . . . , and Nk. Preferably, device property table 35A and object property tables A1-Ai are mapped from intelligent device 15A. Likewise, device property table 35B and object property tables B1-Bj are preferably mapped from intelligent device 15B. Further, device property table 35N and object property tables N1-Nk are preferably mapped from intelligent device 15N.

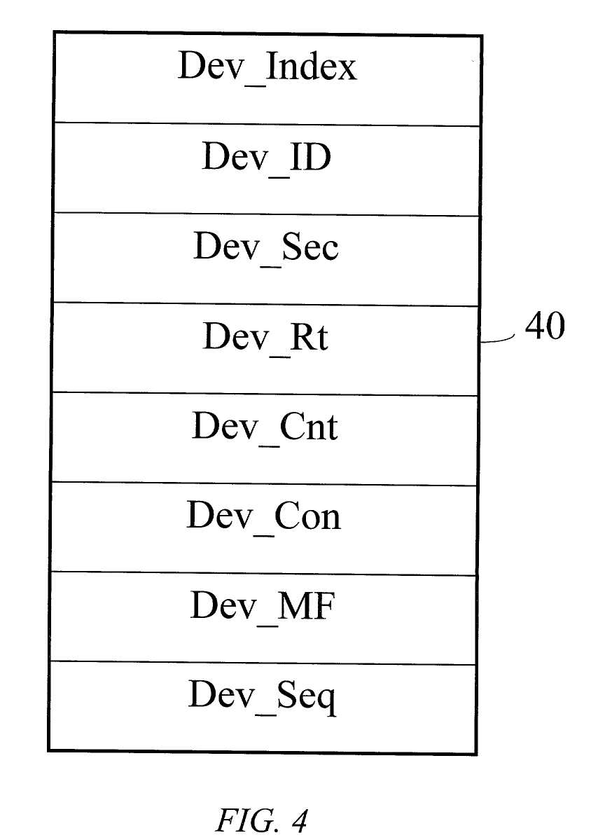

FIG. 4 illustrates the structure of a device 40 in device index table 32 in database 30 of network server 20 in accordance with the present invention. Device 40 can be any of entries DEV_A, DEV_B, . . . , and DEV_N in device index table 32 shown in FIG. 3. By way of example, device 40 is entry DEV_A in device index table 32 corresponding to intelligent device 15A in Intranet 16. Device 40 preferably has eight elements: device index (Dev_Index), device digital identifier (Dev_ID), device security code (Dev_Sec), device communication route (Dev_Rt), device client access count (Dev_Cnt), device connection status (Dev_Con), device property mapping frequency (Dev_MF), and device data packet sequence (Dev_Seq).

The device index (Dev_Index) preferably lists an index to intelligent device 15A, in Intranet 16. In a preferred embodiment, the Dev_Index (Dev_Index) stores the name of intelligent device 15A. The device digital identifier (Dev_ID) stores a digital identifier uniquely identifies intelligent device 15A. Typically, the device digital identifier is set by the manufacturer of intelligent device 15A. In order to access intelligent device 15A, a client is preferably required to provide a security code matching the device security code (Dev_Sec) in device 40 of device index table 32. The device communication route (Dev_Rt) preferably specifies device communication protocol, port, address or telephone number, and communication speed for intelligent device 15A.

The device client access count (Dev_Cnt) describes the number of clients that are currently accessing intelligent device 15A through network server 20. For example, the device client access count (Dev_Cnt) is initially zero. When a client, which may be a client on network 11 or client 12, seeks to access intelligent device 15A through network server 20, the device client access count (Dev_Cnt) in device 40 of device index table 32 is set to one. For any subsequent client, which may be either a client on network 11 or client 12, seeking access to intelligent device 15A through network server 20, the device client access count (Dev_Cnt) in device 40 of device index table 32 increases by one. In response to any client terminating the access to intelligent device 15A, the device client access count (Dev_Cnt) in device 40 of device index table 32 decreases by one. Thus, the device client access count (Dev_Cnt) in device 40 of device index table 32 indicates how many clients are accessing intelligent device 15A through network server 20. The device client access count (Dev_Cnt) being zero indicates that there is no client accessing intelligent device 15A through network server 20. It should be noted that a particular intelligent device, e.g., intelligent device 15A, may belong to several Intranets. FIG. 1 shows intelligent device 15A belonging to both Intranet 16 and Intranet 19. The device client access count (Dev_Cnt) in device 40 of device index table 32 of network server 14 being zero indicates that no client is accessing intelligent device 15A through network server 14. This does not necessarily mean that there is no client accessing intelligent device 15A through another network server, e.g., network server 18.

The device connection status (Dev_Con) indicates the whether network server 20 is currently connected to intelligent device 15A, thereby permitting data transmission there between. By way of example, the device connection status (Dev_Con) has one bit, which is equal to zero when network server 20 is not connected to intelligent device 15A and is equal to one when network server 20 is connected to intelligent device 15A.

The device property mapping frequency (Dev_MF) specifies how frequent the device property table and the object property tables are mapped from intelligent device 15A into database 30. It should be noted that mapping can be performed only when network server 20 is connected to intelligent device 15A. A higher mapping frequency generally keeps database 30 more updated with the objects in intelligent device 15A. A lower mapping frequency is typically more power efficient. Preferably, a client coupled to network server 20 can specify the value of the device property frequency (Dev_MF) in device 40 on device index table 32. Further, the device property mapping frequency (Dev_MF) can preferably also determined by an administrator of network server 20. As an example, intelligent device 15A is a utility meter, and the device property mapping frequency (Dev_MF) may be set by the utility company at a value of one mapping every week. As another example, intelligent device 15A is a medical monitoring device, and the device property mapping frequency (Dev_MF) may be set by the monitoring service provider at a value of one mapping every minute.

The device data packet sequence (Dev_Seq) in device 40 of device index table 32 serves to distinguish different data packets transmitted to intelligent device 15A from network server 20. It should be noted that data transmission between network server 20 and intelligent device 15A can be performed only when network server 20 is connected to intelligent device 15A. When network server 20 transmits a data packet to intelligent device 15A, the device data packet sequence (Dev_Seq) in device 40 of device index table 32 increases by one. If the data packet transmission fails, which may be due to various factors such as, for example, connection interruption, interference, equipment failure, etc., network server 20 will retransmit the data packet. Retransmitting the data packet does not increase the device data packet sequence (Dev_Seq). Therefore, intelligent device 15A can recognize whether a data packet from network server 20 is a new data packet or a retransmitted data packet through the device data packet sequence (Dev_Seq). In a preferred embodiment, the device data packet sequence (Dev_Seq) in device 40 of device index table 32 is the remainder of the data packet sequence number modulus to an predetermined number such as, for example, six, seven, eight, etc.

It should be understood that device 40 is not limited to having eight elements as described herein above and shown in FIG. 4. Depending of the application, some of the elements in device 40 are optional. For example, the device communication route (Dev_Rt) is optional if Intranet 16 has only one communication protocol, e.g., RS-485. The device security code (Dev_Sec), the device client access count (Dev_Cnt), the device property mapping frequency (Dev_MF), and device data packet sequence (Dev_Seq) may also be optional in device 40 of device index table 32.

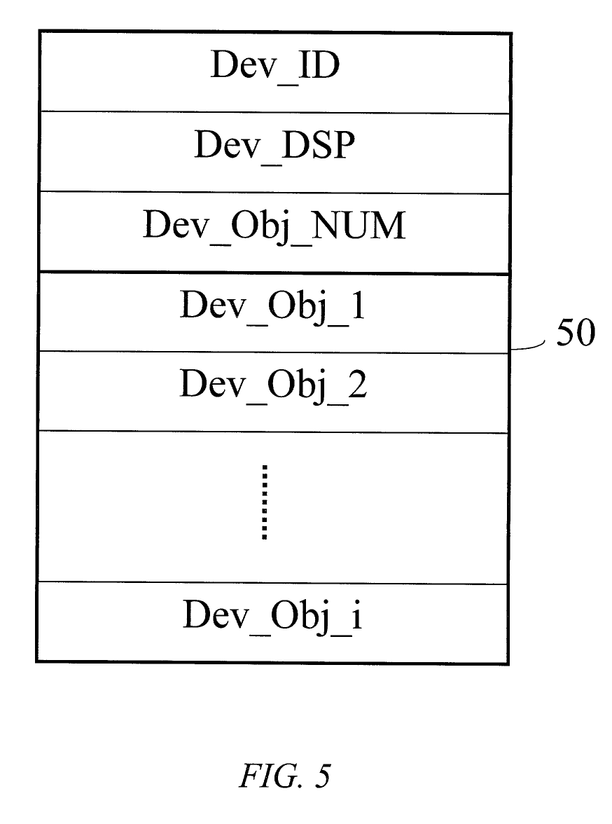

FIG. 5 illustrates a device property table 50 in database 30 of network server 20 in accordance with the present invention. Device property table 50 can be any of device property tables 35A, 35B, . . . , 35N in database 30. By way of example, device property table 50 represents device property tables 35A in database 30 for characterizing intelligent device 15A in Intranet 16. Device property table 50 lists objects associated with intelligent device 15A. For example, if intelligent device 15A is a color television, the associated objects may include television channel frequencies, brightness, color, tint, volume, bass level, treble level, etc.

As shown in FIG. 5, device property table 50 includes a device digital identifier (Dev_ID). Preferably, the device digital identifier (Dev_ID) in device property table 50 is the same as that in device 40 in device index table 32. The device digital identifier establishes the one to one correspondences between device 40 in device index table 32 and device property table 50. Device property table 50 preferably also includes a device descriptor (Dev_DSP) that describes byte length of the address code of intelligent device 15A and data transmission mode, e.g., higher byte first or lower byte first, between network server 20 and intelligent device 15A. Device property table 50 further includes a device object number (Dev_Obj_NUM) that indicates the number of objects associated with intelligent device 15A. For each object, device property table 50 preferably includes an object name (Dev_Obj_1, Dev_Obj_2, Dev_Obj_i). Referring back to FIG. 3, the object names in device property table 35A point to corresponding object property tables (A1, A2, . . . , Ai) in database 30 associated with intelligent device 15A. Likewise, the object names in device property table 35B point to corresponding object property tables (B1, B2, . . . , Bj) in database 30 associated with intelligent device 15B. Further, the object names in device property table 35N point to corresponding object property tables (N1, N2, . . . , Nk) in database 30 associated with intelligent device 15N.

It should be understood that the structure of device property table 50 is not limited to that described herein above and shown in FIG. 5. For example, the device object number (Dev_Obj_NUM) is optional in device property table 50. In one alternative embodiment, the information regarding the number of the objects associated with intelligent device 15A is included in the device descriptor (Dev_DSP). In another alternative embodiment, the number of the objects associated with intelligent device 15A is determined by the number of object name entries (Dev_Obj_1, Dev_Obj_2, . . . , Dev_Obj_i) in device property table 50.

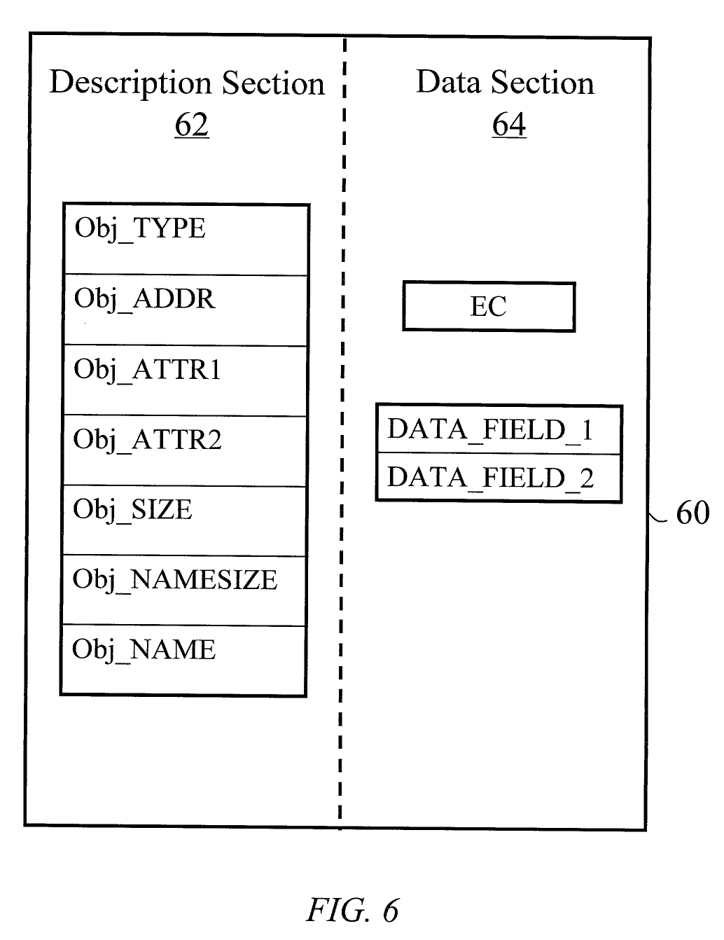

FIG. 6 illustrates an object property table 60 in database 30 of network server 20 in accordance with the present invention. Object property table 60 can be any of object property tables A1-Ai, B1-Bj, . . . , and N1-Nk describing objects associated with respective intelligent devices 15A, 15B, . . . , and 15N. By way of example, object property table 60 represents object property tables A1 in database 30 for describing an object associated with intelligent device 15A in Intranet 16.

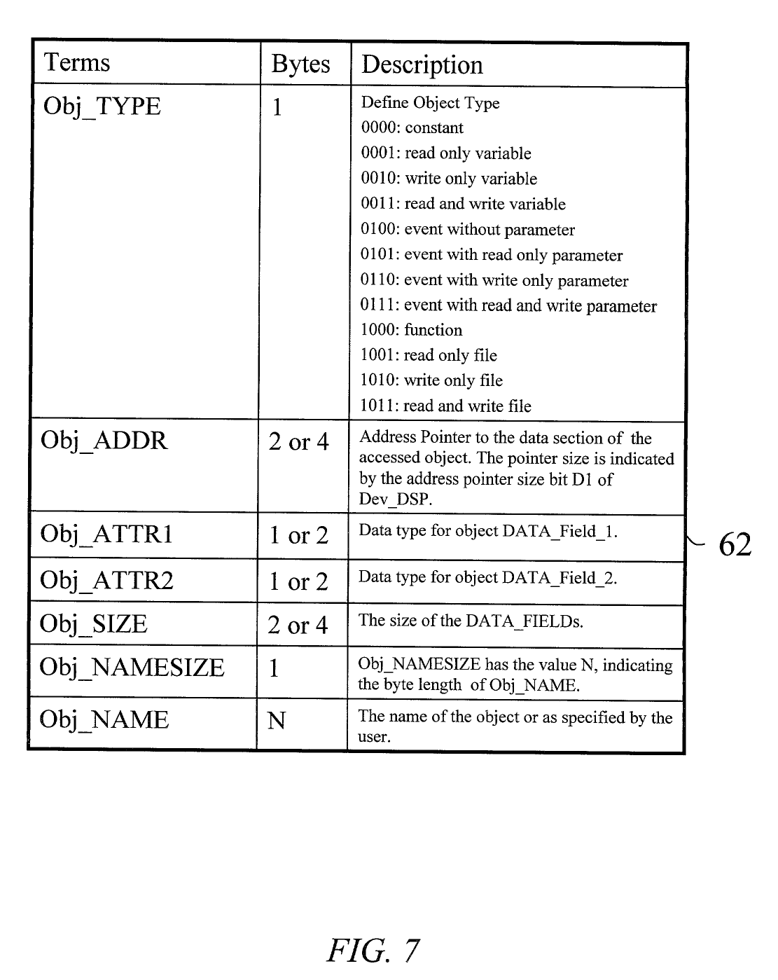

As shown in FIG. 6, object property table 60 includes a description section 62 comprised of an object type description (Obj_TYPE), an object address pointer (Obj_ADDR), an object data attribution (Obj_ATTR1 and Obj_ATTR2), an object data size (Obj_SIZE), an object name size (Obj_NAMESIZE), and an object name (Obj_NAME). The byte length and the function of each term in description section 62 are described in FIG. 7 by way of example. In a preferred embodiment, the object types include constant, read only variable, write only variable, read and write variable, event without parameter, event with read only parameter, event with write only parameter, event with read and write parameter, read only file, write only file, read and write file, and function. Depending on the object type, Obj_ADDR in description section 62 can point to different addresses. Obj_NAME serves to identify the object associated with object property table 60. Obj_NAME can be various types of data such as, for example, binary, ASCII, UNICODE, etc. It should be noted that Obj_ADDR is optional in object property table 60.

Object property table 60 also includes a data section 64 comprised of a plurality of data fields, including an event control field (EC), a DATA_FIELD_1, and a DATA_FIELD_2. However, object property table 60 in accordance with the present invention is not limited to establishing three data fields as shown in FIG. 6. Depending on the applications of intelligent device 15A, any number of data fields, e.g., one, two, four, five, etc., can be established in data section 64 of object property table 60. The data types of DATA_FIELD_1 and DATA_FIELD_2 include unsigned and signed binary, unsigned and signed word, unsigned and signed double word, floating point data, ASCII, UNICODE, etc.

The object described by object property table 60 can be constants, variables, events, functions, and files.

A constant is generally used for describing a fixed parameter object such as, for example, the name, serial number, model number, edition, number, protocol, etc. of intelligent device 15A. In this context, the constant functions as an object identifier. The constant can also include parameters for describing other object characteristics as defined by the user. The constant is preferably a read only data in order to maintain its constancy.

A constant needs to fill only one data field, e.g., DATA_FIELD_1. Thus, DATA_FIELD_2 is blank when the object described by object property table 60 is a constant. In one preferred embodiment, the optional Obj_ADDR points to DATA_FIELD_1, which stores the value of the constant, Obj_ATTR2 stores the code of the constant name, and Obj_NAME is blank. In this embodiment, Obj_ATTR1 describes the data type of the constant value stored in DATA_FIELD_1 and Obj_SIZE is set to be the size of DATA_FIELD_1. In another preferred embodiment, the optional Obj_ADDR points to Obj_NAME, which stores the value of the constant, Obj_ATTR2 stores the code of the constant name, and DATA_FIELD_1 is blank. In this embodiment, Obj_ATTR1 describes the data type of the constant value stored in Obj_NAME and Obj_SIZE is set to be zero. In yet another preferred embodiment, where the constant is represented by its value only, the optional Obj_ADDR is pointed to DATA_FIELD_1, which stores the value of the constant, and Obj_NAME is blank. In this embodiment, Obj_ATTR1 describes the data type of the constant value stored in DATA_FIELD_1, Obj_ATTR2 is blank, and Obj_SIZE is set to be the size of DATA_FIELD_1. In an additional embodiment, where the constant is also represented by its value only, the optional Obj_ADDR is pointed to Obj_NAME, which stores the value of the constant, and DATA_FIELD_1 is blank. In this embodiment, Obj_ATTR1 describes the data type of the constant value stored in Obj_NAME, Obj_ATTR2 is blank, and Obj_SIZE is set to be zero.

A variable typically represents those quantities that do not have fixed values, e.g., temperature, humidity, current, voltage, time, etc. A variable has only one data field, e.g., DATA_FIELD_1. Thus, DATA_FIELD_2 can be left blank when the object described by object property table 60 is a variable. The optional Obj_ADDR points to DATA_FIELD_1, which stores the value of the variable, and Obj_ATTR1 describes the data type of the variable stored in DATA_FIELD_1. Obj_SIZE is set to the size of DATA_FIELD_1. In one preferred embodiment, Obj_NAME stores the name of the variable and Obj_ATTR2 is left blank. In another preferred embodiment, Obj_ATTR2 stores the code of the variable name and Obj_NAME is left blank. The type of a variable can be read only, write only, or read and write.

The type of the object described by object property table 60 can also be an event. By way of example, an event may be the triggering of an alarm in a home security system, a temperature surpassing a user defined temperature upper limit in an air conditioning system, a carbon monoxide concentration over a safe limit, a noise level passing a certain decibel level, etc. An event is represented by the EC in object property table 60. As showing FIG. 7, an event object can be an event without parameter, an event with read only parameter, an event with write only parameter, or an event with read and write parameter

In a preferred embodiment, EC includes a byte referred to as an event control byte (ECB). Bit D7 in the ECB indicates whether the event can be reported from intelligent device 15A to network server 20 and, therefore, is referred to as an enabling bit. For example, when the enabling bit D7 is one, the reporting is enabled and the event can be reported to network server 20. On the other hand, when the enabling bit D7 is zero, the reporting is disabled. The enabling bit D7 is set by network server 20. Bit D6 indicates whether the event is triggered by a change in certain parameters, e.g., temperature, humidity, carbon monoxide concentration, noise decibel, etc., and is sometimes referred to as a parameter bit. The parameter bit D6 is set by intelligent device 15A. There are two situations in which the parameter bit D6 is zero. One is that the event is not associated with a parameter, and the other is that the event is not triggered by the parameter associated therewith or the parameter is not to be reported to network server 20. Intelligent device 15A sets the parameter D6 in the ECB to one when the event is triggered by a parameter and that parameter is to be reported to network server 20 with the event. When intelligent device 15A reports an event triggered by a parameter, the parameter is stored in DATA_FIELD_1. Intelligent device 15A sends an address pointer of DATA_FIELD_1 when intelligent device 15A reports the event to network server 20. Bits D5, D4, and D3 are reserved for future development. Bit D2 is a user defined bit. Bit D1 is referred to as a connection bit and indicates whether the event requires intelligent device 15A to be connected to network server 20 when the event happens. If intelligent device 15A is already connected to network server 20 when the event is triggered, the connection bit D1 in ECB is ignored. Bit D0 is referred to as an event status bit. The event status bit D0 is set to one upon the triggering of the event. After reporting the event to network server 20 and receiving a confirmation signal from network server 20 in a subsequent event polling command, intelligent device 15A resets the event status bit D0 to zero.

In another preferred embodiment, the EC includes a word referred to as an event control word (ECW). The lower byte of the ECW describes the event in the same way as the ECB described herein above. The higher byte of the ECW indicates the priority of the event. If there are several events to be reported when network server 20 sends an event polling command to intelligent device 15A, the event having the highest priority in the higher byte of the ECW is reported first.

Like that of a variable, the name of an event can be stored in Obj_NAME and the code of the event name can be stored in Obj_ATTR2. The optional Obj_ADDR points to EC. An event has at most only one data field, e.g., DATA_FIELD_1. Thus, DATA_FIELD_2 can be left blank when the object described by object property table 60 is an event. When the parameter bit D6 in EC is zero, there is no parameter reporting to network server 20. In this situation, Obj_ATTR1 and DATA_FIELD_1 can be blank. When the parameter bit D6 in EC is one, there is a parameter reporting from intelligent device 15A to network server 20. The parameter can be stored in DATA_FIELD_1. Obj_ATTR1 indicates the data type of the parameter stored in DATA_FIELD_1. Obj_SIZE indicates the size of DATA_FIELD_1. EC includes an address code pointing to DATA_FIELD_1.

A function includes an input parameter and an output parameter. Network server 20 transmits an input parameter to intelligent device 15A. Intelligent device 15A receives the input parameter, executes the input parameter, and generates an output parameter. In a preferred embodiment, the input parameter is a write only data and the output parameter is a read only data with respect to network server 20. Because it includes both input and output parameters, the function generally requires two data fields. DATA_FIELD_1 can store the input parameter and DATA_FIELD_2 can store the output parameter. The optional Obj_ADDR is points to DATA_FIELD_1. Obj_ATTR1 and Obj_ATTR2 indicate the data types of the input and output parameters, respectively. Obj_SIZE is divided into two segments. The first segment indicates the size of DATA_FIELD_1 and the second segment indicates the size of DATA_FIELD_2. Obj_NAME stores the name of the function.

A file object described by object property table 60 can be any kind of file, e.g., text file (.txt), binary file (.bin), hexadecimal file (.hex), executable file (.exe), image file (.gif), word document file (.doc), hypertext mark language file (.html), etc. Because the file requires only one data field, e.g., DATA_FIELD_1, DATA_FIELD_2 can be blank for the file object. The optional Obj_ADDR points to DATA_FIELD_1. Obj_ATTR1 indicates the data type of the file in DATA_FIELD_1, and Obj_SIZE indicates the size of the file in DATA_FIELD_1. In one preferred embodiment, Obj_NAME stores the name of the file and Obj_ATTR2 is left blank. In an alternative preferred embodiment, Obj_ATTR2 stores the code of the file name and Obj_NAME can store the file name or be left blank. The type of the file can be read only, write only, or read and write.

Device property table 35A with corresponding object property tables A1-Ai, device property table 35B with corresponding object property tables B1-Bj, . . . , and device property table 35N with corresponding object property tables N1-Nk (shown in FIG. 3) in database 30 are mapped from respective intelligent devices 15A, 15B, . . . , and 15N. When network server 20 is connected to intelligent device 15A, the device property table and the object property tables in intelligent device 15A are mapped into database layer 26 of network server 20, thereby setting up device property table 35A and corresponding object property tables A1-Ai in database 30. Likewise, when network server 20 is connected to intelligent device 15B, the device property table and the object property tables in intelligent device 15B are mapped into database layer 26 of network server 20, thereby setting up device property table 35B and corresponding object property tables B1-Bj in database 30. Similarly, when network server 20 is connected to intelligent device 15N, the device property table and the object property tables in intelligent device 15N are mapped into database layer 26 of network server 20, thereby setting up device property table 35N and corresponding object property tables N1-Nk in database 30. In a preferred embodiment, the mapping process is performed periodically from any of intelligent devices 15A-15N that is connected to network server 20 according to the value of the respective device property mapping frequency (Dev_MF) in device index table 32. The periodical mapping processes keep database 30 in network server 20 updated or substantially synchronized with the parameters in intelligent devices 15A-15N. The device property table and object property table mappings significantly increase the efficiency and speed of the data transfer from intelligent devices 15A-15N to network server 20.

Database 30 provides an object oriented communication process that significantly simplifies the process by which a client accesses intelligent devices 15A-15N through network server 20. The object oriented communication process enables network server 20 to be application platform independent. In other words, the network server 20 is compatible with intelligent devices 15A-15N operating on different application platforms. Database 30 enables a client on network 11 or client 12 to access and manage the objects associated with intelligent devices 15A-15N without interfering with the operation of intelligent devices 15A-15N.

Network sever 20 sets up and maintains database 30 though device property table and object property table mappings. When a client seeks to access a parameter corresponding to an object associated with an intelligent device, e.g., intelligent device 15A, in Intranet 16, the client does not access intelligent device 15A directly. Instead, the client accesses device 40 through device index table 32 in database 30 of network server 20. Database 30 verifies the device security code (Dev_Sec) in device 40 to determine the device access authority and limitation of the client. The device client access count (Dev_Cnt) in device 40 of device index table 32 increases by one in response to the client seeking access to intelligent device 15A through network server 20. When the client terminates its access to intelligent device 15A, the device client access count (Dev_Cnt) in device 40 of device index table 32 decreases by one.

If the client seeks to read data regarding an object associated with intelligent device 15A, a reading process reads the data from database 30 in network server 20. In accordance with the present invention, the client can preferably read data regarding an object associated with intelligent device 15A using either a read command (READ) or a real time read command (RT_READ) transmitted to network server 20. In response to the READ command, network server 20 access the object property table in database 30 and transmits the value of stored in the object property table in database 30 to the client. The execution of the READ command does not require intelligent device 15A to be connected with network server 20. Through the READ command, the client reads the data currently stored in database 30. On the other hand, in response to the RT_READ command, network server 20 first seeks the object in intelligent device 15A. This requires the connection between network server 20 and intelligent device 15A. Therefore, if the device connection status (Dev_Con) in device index table 32 is zero, indicating network server 20 being disconnected from intelligent device 15A, network server 20 will initiate the connect process to intelligent device 15A in response to the RT_READ command. After establishing the connection with intelligent device 15A, network server 20 transmits a read command to intelligent device 15A to read the object data from the object property table in intelligent device 15A into the corresponding object property table in database 30. Subsequently, network server 20 transmits the object data in database 30 to the client. Through the RT_READ command, the client reads the data stored in database 30 that is transmitted from intelligent device 15A in response to the RT_READ command. If the connection between network server 20 and intelligent device 15A is established in order to execute the RT_READ command, network server 20 preferably initiates a disconnection process to disconnect intelligent device 15A therefrom after reading data from intelligent device 15A. If network server 20 is connected to intelligent device 15A before the execution of the RT_READ command, the RT_READ command simply does not change the connection status between network server 20 and intelligent device 15A.

If the client seeks to modifies the data regarding an object associated with intelligent device 15A, a writing process writes the data into the corresponding object property table in database 30 of network server 20. Subsequently, link service layer 24 in network server 20 generates a write command to intelligent device 15 to write the data into the corresponding object property table in intelligent device 15. In accordance with the present invention, the client can preferably modify data regarding an object associated with intelligent device 15A using either a write command (WRITE) or a real time write command (RT_WRITE) transmitted to network server 20. In response to the WRITE command, network server 20 transmits a write command to intelligent server 15A if network server 20 is already connected to intelligent device 15A. Otherwise, network server 20 waits until network server 20 and intelligent device 15A are connected with each other before transmitting the write command to intelligent device 15A. In other words, in response to the WRITE command from the client, network server 20 does not initiate the connection process to intelligent device 15A. On the other hand, in response to the RT_WRITE command, network server 20 will initiate the connection process to intelligent device 15A if network server 20 is not already connected to intelligent device 15A. After establishing the connection with intelligent device 15A, network server 20 transmits a write command to intelligent device 15A to write the object data from database 20 to the object property table in intelligent device 15A. If the connection between network server 20 and intelligent device 15A is established in order to execute the RT_WRITE command, network server 20 preferably initiates a disconnection process to disconnect intelligent device 15A therefrom after writing data to intelligent device 15A. If network server 20 is connected to intelligent device 15A before the execution of the RT_WRITE command, the RT_WRITE command simply does not change the connection status between network server 20 and intelligent device 15A. Both the WRITE and RT_WIRTE commands preferably have higher priority than the periodical mapping processes that maps the device property table and object property tables in intelligent device 15A into database 30 of network server 20. Thus, the WRITE and RT_WIRTE commands may interrupt a mapping process in order to ensure that the new data is written into intelligent device 15A before it is erased from database 30 by the mapping process.

Database 30 significantly simplifies the process of accessing an object. The shared environment provided by the database 30 in network server 20 also enables one intelligent device, e.g., intelligent device 15A, to access the objects associated with another intelligent device, e.g., intelligent device 15B, in Intranet 16. Likewise, intelligent device 15B can exchange data with intelligent device 15A through network server 20 in the shared environment established by database 30. In accordance with the present invention, as database is preferably set up in each network server, e.g., each of network servers 14 and 18 in respective Intranets 17 and 19, in communication system 10 as shown in FIG. 1. This will enable multiple clients on networks 11 and 17 to simultaneously access an intelligent device, e.g., intelligent device 15A through respective network servers 14 and 18.

Network server 20 and intelligent device 15A have a master-slave relationship with respect to each other. Only network server 20 can initiate command signals. Intelligent device 15A responds the command signals transmitted from network server 20 by sending response command signals to network server 20. If intelligent device 15A does not respond a command signal from network server 20, network server 20 preferably repeats transmitting the command signal to intelligent device 15A until intelligent device 15A responds. After a predetermined number of command signal transmissions without response from intelligent device 15A, network server 20 detects a timeout mistake. The command signals from network server 20 and the response command signals from intelligent device 15A are transmitted in data packets. Preferably, intelligent device 15A transmits a data packet to network server 20 only in response to a date packet transmitted from network server 20. All data packets transmitted between network server 20 and intelligent devices 15A-15N have substantially the same structure.

Information regarding a particular object is preferably transmitted between network server 20 and intelligent device 15A in the form of data packets. A data packet transmitted between network server 20 and intelligent device 15A preferably includes a server identification segment, a status segment, a command segment, and a data segment.

The server identification segment serves to enable intelligent device 15A to identify and distinguish different network servers accessing intelligent device 15A. In one preferred embodiment, network server 20 is identified by a predetermined parameter such as, for example, network server name, serial number, security code, or the like. In another preferred embodiment, network server 20 generates a random number each time it is connected to intelligent device 15A. The random number functions as the server identifier of network server 20. The random number is released when network server 20 is disconnected from intelligent device 15A. The random number can have any byte length. The byte length of the random number determines the probability of two network servers using the same number as their server identifiers when accessing intelligent device 15A, which will result in intelligent device 15A unable to distinguish the two network servers. In a preferred embodiment, the server identifier in a command from network server 20 is a number of four bytes randomly generated each time network server 20 is connected to one of intelligent devices 15A-15N.

By way of example, the status segment is one byte long. Bit D7 is referred to as event bit. The event bit D7 is set by intelligent device 15A in a response signal to network server 20. The event bit D7 indicates whether intelligent device 15A has an event to be reported to network server 20. Bit D6 is referred to a busy bit. The busy bit D6 is also set by intelligent device 15A in a response signal to network server 20. The busy bit D6 indicates whether intelligent device 15A is busy and cannot properly execute the command signals from network server 20. After receiving the busy signal from intelligent device 15A, network server 20 periodically sends polling commands to intelligent device 15A inquiring the status of intelligent device 15A. Bit D5 is transmission direction bit indicating whether the data packed is a down link data packet transmitted from network server 20 to intelligent device 15A or an up link data packet transmitted from intelligent device 15A to network server 20. Bits D4-D3 in the status segment of a data packet is reserved for future development. Bits D2-D0 are referred to as sequence bits. The sequence bits D2-D0 of a down link data packet transmitted from network server 20 to intelligent device 15A include a sequence number set by network server 20. The sequence number provides an identification of the data packet, as described herein above with reference to FIG. 3. When intelligent device 15A transmits a response signal to network server 20, the up link data packet in the response signal includes the sequence number set by the network server 20. The sequence number in the response signal up link data packet enables network server 20 to recognize to which down link data packet the up link data packet from intelligent device 15A is responding. This data packet correspondence recognition capability is especially beneficial when network server 20 communicates simultaneously with a plurality of intelligent devices, e.g., intelligent devices 15A-15N.

The command segment controls the signal transmission between network server 20 and intelligent device 15A. In one preferred embodiment, the command segment has five bytes: one byte for the command, two bytes for command parameter, and two bytes for command subparameter. The command parameter and command subparameter serves to supplement the command byte for correct and efficient command transmission and execution. The command byte has two parts, command type and command status. By way example, bits D4-D0 make up the command type, and bits D7-D5 make up the command status. The command type includes control command, setup command, read command, write command, etc. In a preferred embodiment, the command status includes a MORE bit (D7), an ERROR bit (D6), and a RESPONSE ENABLING bit (D5). The MORE bit (D7) indicates whether the current data packet includes all data to be transferred. The value in the ERROR bit (D6) is set in a response command, indicating whether the initial command has been successfully received and executed. The RESPONSE DISABLING bit (D5) is set by network server 20 for indicating whether network server 20 permits and requires intelligent device 15A to respond the command from network server 20. For example, when the RESPONSE DISABLING bit (D5) in a data packet is set to one, network server 20 does not permit intelligent device 15A to respond to the data packet. Thus, after transmitting a data packet with the RESPONSE DISABLING bit (D5) set to one, network server 20 does not wait for the response from intelligent device 15A. This is beneficial when network server 20 broadcasts messages to many intelligent devices. On the other hand, when the RESPONSE DISABLING bit (D5) in a data packet is set to zero, network server 20 requires intelligent device 15A to respond to the data packet. This is beneficial when network server 20 seeks to control or modify an object associated with intelligent device 15A.

The data segment contains the information to be transmitted between network server 20 and intelligent device 15A. For example, in a READ command data packet, the data segment of the data packet may include DATA_FIELD_1 of object 60 (shown in FIG. 5) in an object property table. The byte length of the data segment is variable depending on the amount of the information to be transmitted.

In accordance with a preferred embodiment, the commands transmitted between network server 20 and intelligent device 15A belong to several categories: connect/disconnect commands, read/write commands, object property table mapping commands, event polling/reporting commands, setup commands, data encryption/decryption commands, data compression/decompression commands, and In-Application re-Programming (IAP) commands. Because of its slave status, intelligent device 15A does not initiate a command to network server 20. Intelligent device 15A only responds to commands from network server 20. A command from network server 20 may requires an in kind response from intelligent device 15A in the sense that READ command from network server 20 requires a response READ command from intelligent device 15A, or the like.

As an exception to the master-slave relationship between network server 20 and intelligent device 15A, both network server 20 and intelligent device 15A can initiate the connection there between. Network server 20 can sent connection commands to intelligent device 15A to establish the connection. The connection command preferably specifies communication types, e.g., RS-485, RS-232, MODEM, USB, etc., between network server 20 and intelligent device 15A. Upon receiving the connection command, intelligent device 15A preferably checks the security in the connection command with the security code in intelligent device 15A. If the security codes match or intelligent device 15A does not have a security code, intelligent device 15A sends a response acknowledging the connection command from network server 20. The response preferably includes the digital ID (Dev_ID), the descriptor segment (Dev_DSP and Dev_Obj_NUM) of the device property table, and parameters regarding the communication capabilities of intelligent device 15A. If the security codes do not match, intelligent device 15A sends response to network server 20 refusing the connection. In a preferred embodiment, the response includes Dev_ID, thereby by informing network server 20 the identity of intelligent device 15A. Intelligent device 15A can also initiate connection by sending a connection request to network server 20. In response to the connection request, network server 20 sends the connection command to intelligent device 15A to establish the connection there between. The device connection status (Dev_Con) in device 40 in device index table 32 of database 30 (shown in FIGS. 3 and 4) is set to one upon establishing the connection between network server 20 and intelligent device 15A.

As a master with respect to intelligent device 15A, network server 20 can send the disconnection command to intelligent device 15A to disconnect network server 20 from intelligent device 15A. The device connection status (Dev_Con) in device 40 in device index table 32 of database 30 (shown in FIGS. 3 and 4) is set to zero in response to network server 20 being disconnected from intelligent device 15A. While being disconnected from network server 20, intelligent device 15A ignores all commands from network server 20 except the connection command.

In accordance with a preferred embodiment of the present invention, network server 20 constantly polls those of intelligent devices 15A-15N that are connected to network server 20 for events. In other words, network server 20 periodically transmits event polling commands to the connected intelligent devices 15A-15N. Intelligent devices 15A-15N report the events triggered therein to network server 20 in response to the event polling commands. Reporting an event to network server 20 will changes and updates the parameter stored in the corresponding object property table in database 30. This is different from mapping the device property table and object property tables to network server 20. In a mapping process, the whole device property table and all object property tables in an intelligent device are mapped into database 30 of network server 20. In an event reporting process, only the data of the triggered event object and its associated parameter are transmitted from the intelligent device to database 30 of network server 20. In accordance with a preferred embodiment, network server 20 polls those of intelligent devices 15A-15B connected thereto for events at higher frequencies than the mapping frequencies at which the corresponding intelligent devices map device and object property tables into database 30 of network server 20. However, this is not a limitation of the present invention. Preferably, an intelligent device, e.g., intelligent device 15A is able to respond to certain types of events, e.g., fire alarm, before reporting the event to network server 20. By way of example, the response to a fire alarm may include activating fire suppression sprinklers, closing the fire safety doors, switching on emergency exit lights, etc. After receiving an event report from intelligent device 15A, network server 20 updates database 30. In addition, network sever 20 may initiate event response programs, reporting the event to a client through an electronic mail. Network server 20 may also report the event to a client in response to an event polling command from the client.

In accordance with a preferred embodiment of the present invention, client management layer 27 of network server 20 (shown in FIG. 2) allows a client to preset a command. Specifically, a client can send a preset command to network server 20 instructing network server 20 to access an object in an intelligent device, e.g., intelligent device 15A, in Intranet 16 at a predetermined time. Network server 20 stores the preset command in a preset command table. At the predetermined time, network server 20 executes the preset command and access the object. When network server 20 executes the preset command, the client may or may not be connected to network server 20. The client can inquire network server 20 about the execution of the preset command at a subsequent time. Alternatively, network server 20 can send an electronic mail to the client to report the execution of the preset command.

By now it should be appreciated that a network server for communicating between a network and intelligent devices in an intelligent device communication network has been provided. In accordance with the present invention, the network server generates a database that includes device object tables and object property tables mapped from the intelligent devices in the intelligent device communication network. The database enables the identification, description, controlling, monitoring, and modification of the devices by a client on the network. In accordance with the present invention, a client coupled to the network server does not directly access an intelligent device in the intelligent device communication network. Instead, the client accesses the database on the network server. The client may read data from the database. The client may also write data into the database. This indirect access of an intelligent device by the client provides the intelligent device a safe operating environment. The operation of the intelligent devices are insulated from any possible interference from the client on the network. The operation of the intelligent device will not be inadvertently disrupted by the client. When desired, the real time read and write commands enable the client to access the intelligent devices timely. The database further provides an object oriented communication process in the intelligent device communication network. The communication process in accordance with the present invention is application platform, operating system, and device communication protocol independent. The network server and the intelligent devices in the intelligent device communication network have a master-slave relationship, which provides reliable and robust communication links between the network server and the intelligent devices. Using the network server of the present invention, the communication between the intelligent devices and a network, e.g., the Internet, can be established without significantly modifying the software and hardware structures of existing processing circuits, e.g., μP, MCU, DSP, etc., in the devices. The designers of the processing circuits are not required to be familiar with the communication protocol between the network server and the devices. The network server is capable of communicating with μPs, MCUs, DSPs, CPUs, etc., of various capabilities, performances, bit numbers, and memory sizes. Thus, the development time and cost of a device-network communication system in accordance with the present invention are significantly reduced compared with prior art communication systems.

1. A network server for establishing communication between a device and a network, comprising:
a database including an object property table mapped from the device; and
a client management layer receiving a device access request from a client on the network and accessing said database in response to the device access request.

2. The network server of claim 1, said database further storing a device property table mapped from the device, the device property table including a device identifier and a device object name pointing to the object property table.

3. The network server of claim 2, said database establishing a device index table including a device name and a device identifier pointing to the device property table.

4. The network server of claim 3, wherein the device index table further includes a device security code, a device communication route, a device client access count, a device connection status, a device property mapping frequency, and a device data packet sequence.

5. The network server of claim 1, wherein the object property table includes an object description section and a data section.

6. The network server of claim 5, wherein:
the object description section includes an object name, an object type description, and an object size; and
the data section includes an event control field and a first data field.

7. The network server of claim 6, wherein the object type description in the object description section of the object property table defines an event object.

8. The network server of claim 1, said database being updated by periodically mapping the object property table from the device into said database.

9. The network server of claim 1, wherein said database is accessible by a plurality of clients on the network.

10. The network server of claim 1, wherein said database is accessible to another device coupled to the network server.

11. The network server of claim 1, said database reading data from the object property table in said database in response to the device access request.

12. The network server of claim 1, further comprising a link service layer periodically transmitting an event polling command transmitted to the device.

13. The network server of claim 12, said link service layer reading data from the device into the object property table in response to the device access request being a real time read command.

14. The network server of claim 12:
said database writing data into the object property table in response to the device access request; and
said link service layer transmitting the data from said database to the device.

15. The network server of claim 14, said link service layer initializing a connection process to the device and transmitting the data from said database to the device in response to the device access command being a real time write command.

16. The network server of claim 1, said client management layer including a memory storing a preset command transmitted from the client on the network and executing the preset command at a predetermined time.

17. The network server of claim 16, said link service layer reporting an execution of the preset command to the client.

18. The network server of claim 16, said link service layer establishing a master-slave relationship between the network server and the device.

19. The network server of claim 16, said link service layer packing a signal to the device into a data packet having a network server identifier.

20. The network server of claim 1, said database insulating the device from the client on the network.

21. A database in a network server coupled to a network and serving a plurality of devices in an Intranet, the database comprising:
a plurality of object property tables arranged in a plurality of sets, each set of object property tables being associated with one of the plurality of devices in the Intranet;
a plurality of device property tables, each corresponding to one of the plurality of devices in the Intranet and having a plurality of object address codes point to a corresponding set of object property tables; and
a device index table including a plurality of entries corresponding to the plurality of devices in the Intranet, each of the plurality of entries including a device name and a device identifier pointing to a corresponding one of the plurality of device property tables.

22. The database of claim 21, wherein said plurality of object property tables and said plurality of device property tables are periodically mapped from the plurality of devices in the Intranet.

23. The database of claim 21, wherein said plurality of object property tables, said plurality of device property tables, and said device index table are simultaneously accessible by a plurality of clients coupled to the network server.

24. The database of claim 21, each of the plurality of object property tables including an object description section and a data section, wherein:
the object description section includes an object name, an object type description, and an object size; and
the data section includes an event control field and a first data field.

25. The database of claim 24, the object description section in each of said plurality of object property tables further including an object address, wherein:
the object address in the description section points to the event control field of the data section in response to the object type being an event; and
the object address in the description section points to the first data field of the data section in response to the object type being one selected from the group consisting of constant, variable, function, and file.

26. The database of claim 24, wherein the data section further includes a second data field.

27. The database of claim 21, wherein the device index table further includes a device security code, a device communication route, a device client access count, a device connection status, a device property mapping frequency, and a device data packet sequence for each of the plurality of entries.

28. The database of claim 21, wherein at least one of the plurality of object property tables includes a parameter that is a writeable parameter with respect to one of the plurality of devices in the Intranet in response to the one of the plurality of devices reporting an event to the network server.

29. The database of claim 21, wherein at least one of the plurality of object property tables includes a parameter that is a writeable parameter with respect to a client on the network.

30. The database of claim 29, wherein the network server transmits the parameter in the at least one of the plurality of object property tables to one of the plurality of devices in the Intranet in response to the parameter being written by the client on the network.

31. A method for communicating between a network and a plurality of devices, comprising the steps of:
coupling a network server to the network;
coupling the network server to the plurality of devices to form an Intranet;
establishing a database on the network server describing the plurality of devices;
transmitting an access command from a client on the network to the network server; and
accessing the database on the network server in response to the access command.

32. The method of claim 31, further comprising the step of periodically mapping a device property table and a plurality of object property tables from each of the plurality devices to the database on the network server.

33. The method of claim 32, wherein the step of establishing a database further includes the step of generating a device index table including a device name, a device identifier pointing to the of device property table, a device security code, a device client connection status, count, and a device property mapping frequency.

34. The method of claim 32, wherein the step of periodically mapping a device property table and a plurality of object property tables includes the steps of:
generating an object description section and a data section for each of the plurality of object property tables, the object property section including an object name, an object type description, and an object size, and the data section including an event control field, a first data field, and a second data field; and
generating a device identifier and a plurality of device object names in the device property table, the plurality of device object names pointing to the plurality object property table.

35. The method as claimed in claim 31, further comprising the step establishing a master-slave relationship between the network server and the plurality of devices in the Intranet.

36. The method of claim 31, further comprising the step of simultaneously accessing, by a plurality of clients on the network, the database in the network server.

37. The method of claim 31, further comprising the step of reading a data from the database in the network server.

38. The method of claim 37, wherein the step of reading a data form the database in the network server includes the steps of:
reading the data from one of the plurality of devices into the data base; and
transmitting the data from the database to the network.

39. The method of claim 31, further comprising the steps of:
writing a parameter into the database on the network server; and
transmitting the parameter from the database on the network server to one of the plurality of device.

40. The method of claim 39, wherein the step of transmitting the parameter from the database on the network server to the device includes transmitting the parameter from the database on the network server to the device in response to a connecting state between the network server and the one of the plurality of device.
